(19) United States
(12) Patent Application Publication
(10) Pub. No.: US 2019/0197943 A1
(43) Pub. Date: Jun. 27, 2019

(54) DISPLAY CONTROL APPARATUS, DISPLAY APPARATUS, AND CONTROL METHOD

(71) Applicant: SHARP KABUSHIKI KAISHA, Osaka (JP)

(72) Inventor: TAKAYUKI MIZUNAGA, Sakai City (JP)

(21) Appl. No.: 16/228,160

(22) Filed: Dec. 20, 2018

(30) Foreign Application Priority Data
Dec. 22, 2017 (JP) 2017-246346

(51) Int. Cl. G09G 3/20; G09G 3/36

(52) U.S. Cl. CPC G09G 3/2096; G09G 2310/0297; G09G 3/3674; G09G 3/3685

(57) ABSTRACT

A display control apparatus is configured to perform display control in accordance with image data and includes a first drive circuit configured to perform first display control in accordance with a first image signal denoting part of the image data, a second drive circuit configured to perform second display control in accordance with a second image signal denoting another part of the image data, a signal line connected to the first drive circuit and the second drive circuit and configured to transmit a first signal denoting a timing related to control of the first drive circuit and the second drive circuit. The second drive circuit transmits a second signal over the signal line with the second signal being multiplexed on the first signal, the second signal denoting information generated in accordance with the second image signal.

### BACKGROUND

### 1. Field

The present disclosure relates to a display control apparatus, a display apparatus, and a control method.

### 2. Description of the Related Art

In recent years, thin displays have been widely used. Thin displays are applied to, for example, television sets and portable terminals such as smartphones. Moreover, examples of various types of thin displays include liquid crystal displays, organic electroluminescent (EL) displays, and plasma displays.

Such a display may include a plurality of drive circuits for performing display control. For example, International Patent Publication No. 2012/176686 describes that a first source driver of at least two source drivers supplies, to a second source driver of the at least two source drivers, a first analysis result generated by one of analysis circuits, which one is included in the first source driver.

However, International Patent Publication No. 2012/176686 has to include a cable dedicated to transmission and reception of an analysis result among the plurality of source drivers. However, when a cable is added, the number of cables in a panel and/or substrate cables increases, which may complicate pattern design.

That is, there is a demand for controlling of a plurality of display areas while reducing an increase of the number of cables.

In view of the foregoing, the present disclosure provides a display control apparatus, a display apparatus, and a control method which are configured to control a plurality of display areas while reducing an increase of the number of cables.

One aspect of the present disclosure is a display control apparatus configured to perform display control in accordance with image data, the display control apparatus including a first drive circuit configured to perform first display control in accordance with a first image signal denoting part of the image data, a second drive circuit configured to perform second display control in accordance with a second image signal denoting another part of the image data, a signal line connected to the first drive circuit and the second drive circuit and configured to transmit a first signal denoting a timing related to control of the first drive circuit and the second drive circuit, wherein the second drive circuit transmits a second signal over the signal line with the second signal being multiplexed on the first signal, the second signal denoting information generated in accordance with the second image signal.

Moreover, one aspect of the present disclosure is a display apparatus including the display control apparatus.

Furthermore, one aspect of the present disclosure is a control method of a display control apparatus including a first drive circuit configured to perform first display control in accordance with a first image signal denoting part of the image data, a second drive circuit configured to perform second display control in accordance with a second image signal denoting another part of the image data, a signal line connected to the first drive circuit and the second drive circuit and configured to transmit a first signal denoting a timing related to control of the first drive circuit and the second drive circuit, the control method including transmitting a second signal over the signal line with the second signal being multiplexed on the first signal, the second signal denoting information generated in accordance with the first image signal.

### BRIEF DESCRIPTION OF THE DRAWINGS

FIG. 1 is a view schematically illustrating an appearance of a display apparatus in a first embodiment of the present disclosure.

FIG. 2 is a view schematically illustrating a configuration of the display apparatus in the first embodiment.

FIG. 3A is a time chart illustrating synchronization signals according to a related art.

FIG. 3B is a time chart illustrating an example of a synchronization signal and a parameter signal in the first embodiment.

FIG. 3C is a time chart illustrating the example of a synchronization signal and a parameter signal in the first embodiment.

FIG. 4 is a view schematically illustrating a configuration of a display apparatus in a second embodiment of the present disclosure.

FIG. 5 is a time chart illustrating an example of a synchronization signal and a parameter signal in the second embodiment.

FIG. 6 is a view schematically illustrating a configuration of a display apparatus in a third embodiment of the present disclosure.

FIG. 7 is a view schematically illustrating a configuration of a display apparatus in a fourth embodiment of the present disclosure.

FIG. 8 is a view schematically illustrating a configuration of a display apparatus in a fifth embodiment of the present disclosure.

### DESCRIPTION OF THE EMBODIMENTS

### First Embodiment

Embodiments of the present disclosure will be described below with reference to the drawings.

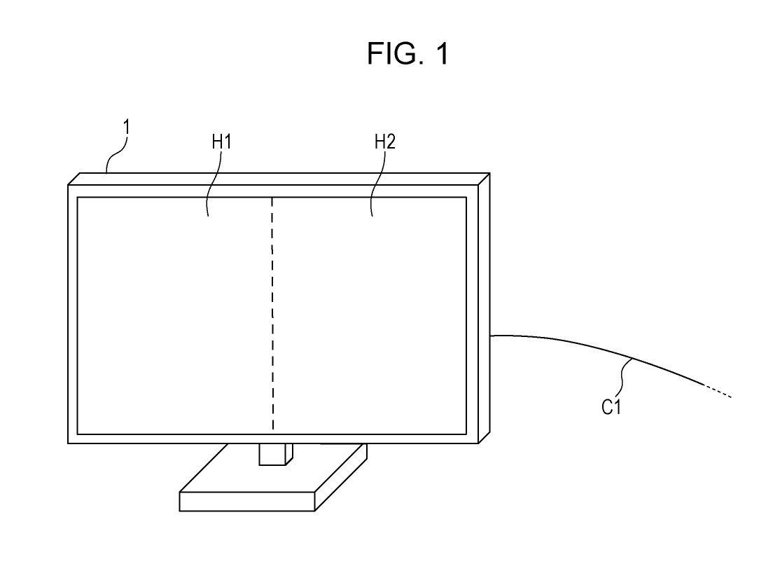

FIG. 1 is a view schematically illustrating an appearance of a display apparatus 1 according to a first embodiment of the present disclosure. The display apparatus 1 is, for example, a television set. Note that the display apparatus 1 may be an electronic display device such as digital signage, a personal computer (PC), a smartphone and a tablet PC, and a navigation device.

The display apparatus 1 has a plurality of display areas, and, for example, the plurality of display areas are combined to display one image. In the example of FIG. 1, the display apparatus 1 has a first display area H1 and a second display area H2 as two areas into which the display is divided.

Note that the display area may include areas obtained by dividing the display into three or more areas or by dividing the display in the vertical direction. Alternatively, the display areas do not have to be divided areas, but some display areas may overlap each other, or a void area may be formed between a display area and another display area. Moreover, no image may be displayed in at least part of the display areas.

The display apparatus 1 acquires a video signal via a video signal line c1 from a video recording device, a tuner, or the like. The display apparatus 1 drives each driver in accordance with the video signal. The display apparatus 1 drives, for example, source drivers and displays images in display areas corresponding to the respective source drivers.

The display apparatus 1 feeds back image parameters to respective integrated circuits. The image parameters are determined by a first integrated circuit (master integrated circuit) in accordance with image analysis results by the plurality of source drivers. Thus, the display apparatus 1 shares the parameters of the respective integrated circuits so as to perform satisfactory image processing. Specifically, the display apparatus 1 performs content adaptive brightness control (CABC) according to an image. In this case, the display apparatus 1 performs the content adaptive brightness control in accordance with the parameters adjusted by the plurality of source drivers.

The display apparatus 1 has to adopt a signal for inputting the image analysis result by each source driver to the first integrated circuit and a signal for feeding back the image parameter to each integrated circuit.

The display apparatus 1 transmits information generated in accordance with an image signal (for example, an image analysis parameter or a display image parameter) between the plurality of integrated circuits over a signal line for transmission of a synchronization signal. That is, the display apparatus 1 transmits the information generated in accordance with the image signal over the signal line for transmission of the synchronization signal, with the information being multiplexed on the synchronization signal.

Thus, the display apparatus 1 enables a plurality of display areas to be controlled while an increase of the number of cables is reduced.

That is, a line for transmission of the synchronization signal for synchronization is provided between the plurality of integrated circuits. The display apparatus 1 multiplexes the information generated in accordance with the image signal on the line for transmission of the synchronization signal. Thus, the display apparatus 1 enables a plurality of display areas to be controlled and satisfactory image processing to be performed without adding a signal or a line. Thus, the display apparatus 1 enables pattern design of a substrate and a display panel to he efficiently performed.

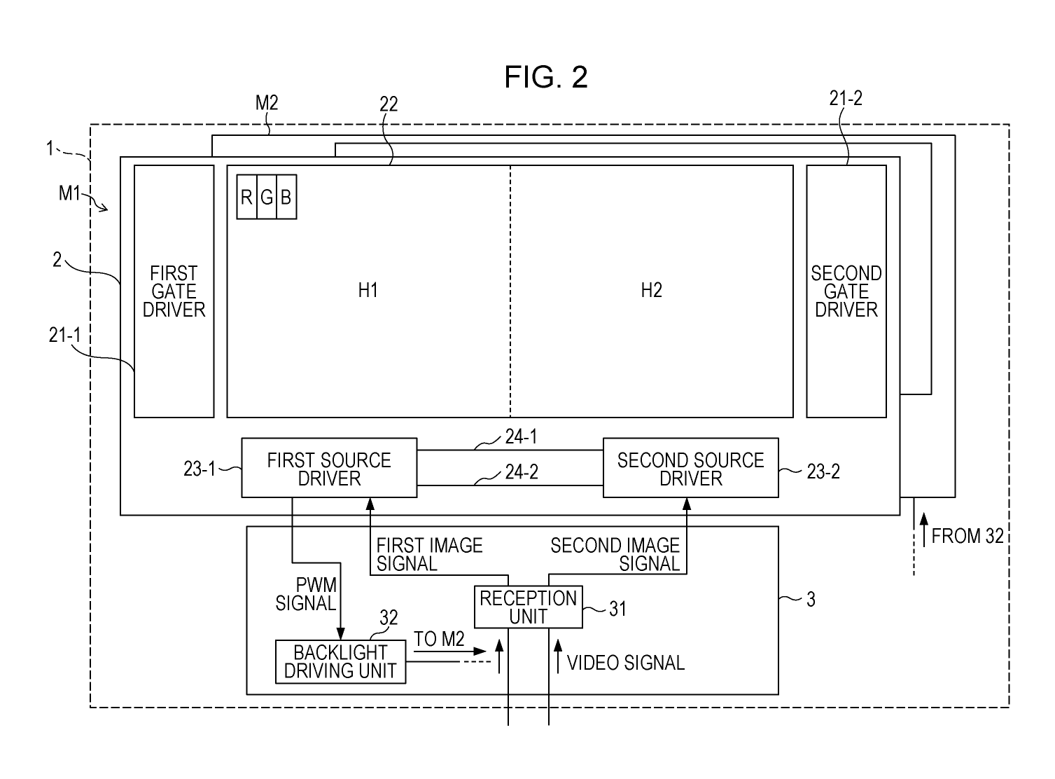

FIG. 2 is a view schematically illustrating a configuration of the display apparatus in the first embodiment. This figure is an example in which the display apparatus 1 is a liquid crystal display.

In this figure, the display apparatus 1 includes a display module M1 and a backlight module M2. The backlight module M2 is disposed on a back surface of the display module M1 and illuminates a display panel 2 of the display module M1. Note that the display apparatus 1 may include other known components.

### Display Module

As illustrated in FIG. 2, the display module M1 includes the display panel 2 and a control substrate 3. The display panel 2 includes a pixel array 22, a first gate driver 21-1, a second gate driver 21-2, a first source driver 23-1, a second source driver 23-2, a first synchronization signal line 24-1, and a second synchronization signal line 24-2. The control substrate 3 includes a reception unit 31 and a backlight driving unit 32.

### Pixel Array

The pixel array 22 includes pixels disposed near intersections of gate bus lines and source bus. Each pixel is connected to its adjacent gate bus line and source bus line. For example, the display apparatus 1 performs color display with three primary colors, namely, R (red), G (green), and B (blue). In this case, each pixel in the pixel array 22 (a first display area H1 and a second display area 112) expresses one color by R, G, and B sub pixels.

The pixel array 22 is a substrate including, for example, an active matrix substrate, a counter substrate, and a liquid crystal layer disposed between the active matrix substrate and the counter substrate. The active matrix substrate includes a pixel electrode and an alignment film disposed on an insulating substrate. Note that the substrate includes a common electrode and an alignment film disposed on another insulating substrate. Note that the active matrix substrate and the counter substrate may be provided with polarizing plates. The pixel includes a pixel electrode. The display panel 2 is capable of operating in, for example, a VA mode.

The pixel array 22, the first gate driver 21-1, the second gate driver 21-2, the first source driver 23-1, and the second source driver 23-2 are, for example, formed on an identical substrate. Moreover, each of the first gate driver 21-1 and the second gate driver 21-2 is disposed in an area in the display panel 2 and outside the pixel array 22.

The display panel 2 included in the display module M1 is divided into a plurality of display areas (the first display area H1 and the second display area H2). In this embodiment, the display panel 2 is a display panel which is not structurally divided, but the present disclosure is not limited to this embodiment, and the display panel 2 may be a display panel which is structurally divided.

### Source Driver

In the example in FIG. 2, the source bus lines of the image array 22 are classified into a plurality of groups. Different source drivers are associated with and connected to the groups of source bus lines. Thus, the first source driver 23-1 is associated with the first display area H1 and performs display control of the first display area H1. The second source driver 23-2 is associated with the second display area H2 and performs display control of the second display area H2.

Note that the first source driver 23-1 or the second source driver 23-2 is generally referred to as a source driver 23.

Specifically, all the source bus lines in the first display area H1 (also referred to as “first source bus lines”) are connected to the first source driver 23-1. Each of the first source bus lines is connected to a corresponding one of the pixels included in the first display area. In the first display area, each pixel expresses a color in accordance with an image signal from the first source driver 23-1, and thereby, an image is displayed as a whole. Similarly, all the source bus lines in the second display area H2 (also referred to as “second source bus lines”) are connected to the second source driver 23-2. Each of the second source bus lines is connected to a corresponding one of the pixels included in the second display area, in the second display area, each pixel expresses a color in accordance with an image signal from the second source driver 23-2, and thereby, an image is displayed as a whole.

Note that the first source driver 23-1 is described as a first integrated circuit (master integrated circuit), and the second source driver 23-2 is described as a second integrated circuit (slave integrated circuit).

Each source driver 23 receives, for example, an image signal denoting an image in a display area associated therewith. For example, each image signal is externally transmitted to a corresponding one of the source drivers based on a mobile industry processor interface (MIPI) (D-PHY) specification. As used herein, the MIPI specification refers to one of specifications configured to transmit an image signal by a differential signal using two signal lines which are paired and which have characteristics of different signal polarities, namely, a positive polarity and a negative polarity in order to control unwanted radiation noise. In the present embodiment, the image signal is transmitted to each source driver 23 associated with the display area based on the MIPI specification.

Specifically, the first source driver 23-1 receives a first image signal. The second source driver 23-2 receives a second image signal. That is, the first source driver 23-1 receives the first image signal based on image data (left data) of a left half of the screen (first display area). The second source driver 23-2 receives the second image signal based on image data (right data) of a right half of the screen (second display area).

Note that each image signal is generated in accordance with a video signal in accordance with a prescribed rule. The prescribed rule is, for example, that for one frame of image data of a video signal, image data corresponding to each display area is defined as each image signal. The integrated circuit of the display apparatus 1 defines, for example, of pieces of image data generated, one piece of image data corresponding to the first display area H1 as the first image signal, and one piece of image data corresponding to the second display area H2 as the second image signal. The integrated circuit outputs the first image signal to the first source driver 23-1 and outputs the second image signal to the second source driver 23-2. The integrated circuit may be provided to the control substrate 3 or may be provided to a substrate different from the control substrate 3.

The first source driver 23-1 includes a first image analyzing circuit, and the second source driver 23-2 includes a second image analyzing circuit. Each image analyzing circuit analyses an image in accordance with the image signal input to generate an image analysis parameter.

The image analysis parameter is, for example, at least one of a pulse width modulation (PWM) signal, duty ratio information, and other pieces of information,

The second source driver 23-2 (slave integrated circuit) transmits a second image analysis parameter based on the second image signal to the first source driver 23-1 (master integrated circuit).

The first source driver 23-1 controls each integrated circuit in accordance with a first image analysis parameter based on the first image signal and a second image analysis parameter transmitted from the second source driver 23-2.

For example, the first source driver 23-1 determines, in accordance with the first image analysis parameter and the second image analysis parameter, a parameter of an output (corresponding to, for example, the luminance or the light intensity) of backlight and outputs a dimming signal (PWM signal) that denotes the parameter thus determined to the backlight driving unit 32. Thus, the display apparatus 1 (display module M1, first source driver 23-1) enables a parameter based on the entire image to be integrally determined in accordance with the image analysis parameters of the plurality of source drivers 23 and the entire display area to be controlled. Moreover, a dimming signal output to the backlight driving unit 32 reflects an analysis result of the image signal by each source driver 23. Therefore, even when a timing controller is not provided, it is possible to control display without discrepancy between the source drivers.

Moreover, the first source driver 23-1 generates a parameter to be transmitted to the second source driver 23-2 in accordance with the first image analysis parameter and the second image analysis parameter. For example, the parameter is a parameter (display image parameter) used for image processing by the second source driver 23-2 (second display area).

The first source driver 23-1 and the second source driver 23-2 are connected to each other via the first synchronization signal line 24-1 and the second synchronization signal line 24-2. Note that, the first source driver 23-1 and the second source driver 23-2 may be connected to each other via one synchronization signal line (for example, first synchronization signal line 24-1).

Between the first source driver 23-1 and the second source driver 23-2, a synchronization signal is transmitted over the first synchronization signal line 24-1 or the second synchronization signal line 24-2. The synchronization signal is, for example, a signal for synchronizing the integrated circuits. For example, the synchronization signal is a signal for synchronizing timings (gate and source outputs) of image display and is a vertical synchronizing signal (Vsync) or a horizontal synchronizing signal (Hsync).

The second source driver 23-2 transmits a synchronization signal over the first synchronization signal line 24-1 to the first source driver 23-1. Here, the second source driver 23-2 transmits a parameter signal over the first synchronization signal line 24-1 with the parameter signal being multiplexed on the synchronization signal, the parameter signal denoting information (for example, an image analysis parameter) generated in accordance with the second image signal.

Moreover, the first source driver 23-1 transmits a synchronization signal over a second synchronization signal line 24-2 to the second source driver 23-2. Here, the first source driver 23-1 transmits a parameter signal over the second synchronization signal line 24-2 with the parameter signal being multiplexed on the synchronization signal, the parameter signal denoting a parameter (for example, display image parameter) generated in accordance with a plurality of image analysis parameters.

Thus, the display apparatus 1 (display module M1) enables a plurality of display areas to be controlled while an increase of the number of cables is reduced. That is, the display apparatus 1 (display module M1) exchanges a signal denoting information of each integrated circuit by using the synchronization signal, and therefore, a dedicated signal line no longer has to be provided.

### Gate Driver

The first gate driver 21-1 and the second gate driver 21-2 sequentially select a gate bus line and perform opening and closing operation of a switching element in each of the pixels so as to write an image signal written in a corresponding one of the source bus lines into the pixel and cause the image signal written in each pixel to be maintained.

In this case, the first gate driver 21-1 and the second gate driver 21-2 may, for example, alternately and sequentially select a gate bus line from the top in the pixel array area.

Moreover, the first gate driver 21-1 may be associated with the first display area H1 and perform display control of the first display area H1, and the second source driver 21-2 may he associated with the second display area H2 and perform display control of the second display area H2.

In this case, the first gate driver 21-1 stay transmit information generated in accordance with the image signal of the display area H1 associated therewith to the second gate driver 21-2 over the synchronization signal line. Alternatively, the second gate driver 21-2 may transmit information generated in accordance with the image signal of the display area H2 associated therewith to the first gate driver 21-1 over the synchronization signal line.

Moreover, the number of the gate drivers may foe three or more.

Moreover, the gate drivers may be mounted on glass included in the display panel. A mounting form of the gate drivers in this case may be referred to as chip on glass (COG).

### Backlight Driving Unit

The backlight driving unit 32 is included in the control substrate 3 and is connected to the first source driver 23-1. The backlight driving unit 32 receives a dimming signal from the first source driver 23-1. Moreover, the backlight driving unit 32 controls the luminance (or light intensity) of the backlight of a backlight module 102 in accordance with the dimming signal.

Specifically, a power source (not shown) applies a drive voltage to the backlight driving unit 32. The backlight driving unit 32 performs, in accordance with the dimming signal, duty control of the drive voltage which is applied, thereby controlling the luminance (or light intensity) of the backlight.

This enables the first source driver 23-1 to perform CABC according to an image to be displayed in the display module M1 (image array 22: first display area H1 and second display area H2) by the dimming signal.

### As to Multiplex Signal of Synchronization Signal and Parameter Signal

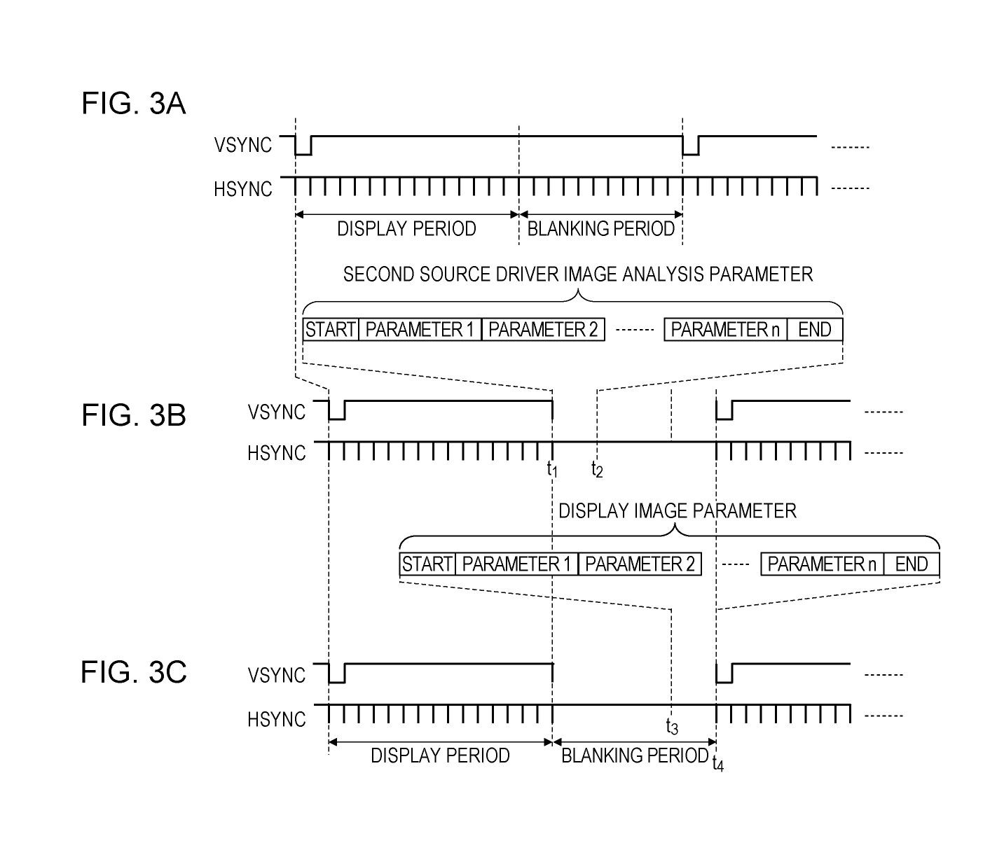

FIGS. 3A to 3C show time charts with reference to which an example of a synchronization signal and a parameter signal in the present embodiment is illustrated. The time charts show waveforms of signals transmitted over at least one signal line of signal lines between the first source driver 23-1 and the second source driver 23-2. In FIGS. 3A to 3C, the horizontal axis is the time axis, and the vertical axis denotes the voltage.

FIG. 3A shows synchronization signals according to a related art. FIG. 3B shows a first multiplex signal transmitted over the first synchronization signal line 24-1. The synchronization signal and the image analysis parameter are time-multiplexed on the first multiplex signal. FIG. 3C shows a second multiplex signal transmitted over the second synchronization signal line 24-2. The synchronization signal and the display image parameter are time-multiplexed on the second multiplex signal.

In FIG. 3A, between the first source driver 23-1 and the second source driver 23-2, two types of synchronization signals (Vsync, Hsync) are transmitted. A period of transmission and reception of these synchronization signals is configured by a display period and a blanking period. During the display period, display control is performed, by the first gate driver 21-1, the second gate driver 21-2, the first source driver 23-1, and the second source driver 23-2.

The blanking period (also referred to as “blanking interval”) refers to a time period for allowing a scan line to return to its initial position after the scan line scans the screen. For example, the blanking period is a time period (horizontal blanking period) for allowing a scan line displayed on the screen (display panel 2) from left to right in the horizontal direction to return to left again. Alternatively, for example, the blanking period is a time period (vertical blanking period) for allowing a scan line displayed on the screen from top left to bottom right in the vertical direction (display panel 2) while scanning from right to left to return to top left again.

In FIG. 3B, an image analysis parameter is inserted into the blanking period of FIG. 3A. That is, the parameter signal of the second image analysis parameter is time-multiplexed on the synchronization signal. This image analysis parameter is a parameter generated by the second source driver 23-2 in accordance with the second image signal.

For example, the second source driver 23-2 stops transmission and reception of the Vsync and the Hsync during the blanking period. The second source driver 23-2 transmits the second image analysis parameter to the first source driver 23-1 during a period from a time t₁ to a time to during the blanking period by using the first synchronization signal line 24-1.

In FIG. 3C, a display image parameter is inserted into the blanking period of FIGS. 3A and 3B. That is, a parameter signal of the display image parameter is time-multiplexed on the synchronization signal. This display image parameter is a parameter generated by the first source driver 23-1 in accordance with the first image analysis parameter and the second image analysis parameter.

For example, the first source driver 23-1 stops transmission and reception of the Vsync and the Hsync during the blanking period. The first source driver 23-1 transmits the display image parameter to the first source driver 23-1 during a period from a time t₃ to a time t₄ during the blanking period by using the second synchronization signal line 24-2.

Note that during the blanking period, a period for transmission of the second image analysis parameter and a period for transmission of the display image parameter may partially or completely overlap each other.

In present embodiment, when transmission and reception of the parameter are performed during the period from the time t₁ to the time t₂ or during the period from the time t₃ to the time t₄, the transmission and reception of the parameter is started with “start period” and ended with “end period”. In order to distinguish the start period and the end period from each other in the present embodiment, specific bit sequences may be adopted and defined uniquely. Alternatively, pulse width modulation may be performed, and an individual duty ratio may be assigned to each of the start period and the end period. During a period between the start period and the end period, the parameter is transmitted and received between the first source driver 23-1 and the second source driver 23-2. For example, in the present embodiment, n types of different image parameters are included.

### Summary of First Embodiment

As described above, in the present embodiment, the display module Ml (display apparatus 1) performs display control in accordance with image data for each one frame. The first source driver 23-1 (an example of a first drive circuit) performs display control (an example of a first display control) in the first display area H1 in accordance with the first image signal denoting part (for example, left half) of one frame of image data. The second source driver 23-2 (an example of a second drive circuit) performs display control (an example of a second display control) in the second display area in accordance with the second image signal denoting another part (for example, right half) of the one frame of image data. The synchronization signal line 24 (an example of the first synchronization signal line 24-1 or the second synchronization signal line 24-2: a signal line) is connected to the first source driver 23-1 and the second source driver 23-2 and is configured to transmit a synchronization signal (an example of a first signal) denoting a timing relating to control of the first source driver 23-1 and the second source driver 23-2. The second source driver transmits a parameter signal (an example of a second signal) over the synchronization signal line 24 with the parameter signal being multiplexed on the synchronization signal, the parameter signal denoting a second image analysis parameter generated in accordance with the second image signal.

In the display apparatus, a line for transmission of the synchronization signal for synchronization is provided between the plurality of integrated circuits. The display module M1 multiplexes the parameter signal generated in accordance with the image signal on the line for transmission of the synchronization signal, and therefore, it is possible to control a plurality of display areas and perform satisfactory image processing without adding a signal or a line. Thus, the display module M1 enables pattern design of a substrate and a display panel to be efficiently performed.

Moreover, the second source driver 23-2 causes a parameter signal to be transmitted during the blanking period (an example of a period between the synchronization signals). Thus, the display module M1 may transmit the parameter signal by using the blanking period.

Note that, for example, the first source driver 23-1 (or the second source driver 23-2) depicts some images of one frame of image data. That is, the number of pixels controlled by the first source driver 23-1 is smaller than the number of pixels of the entire screen (an image shown by one frame of pixel data). In this case, for example, the display module M1 may reduce timings which have to be synchronized by the synchronization signal, and therefore, the number of blanking periods (periods for transmission of the parameter signal) may be increased. For example, the first source driver 23-1 depicts a left half part, which enables each horizontal scanning to be performed in half the time taken to scan the entire screen. When the first source driver 23-1 and the second source driver 23-2 alternately perform the horizontal scanning, the first source driver 23-1 may transmit the parameter signal, where the blanking period is a period during which the second source driver 23-2 performs the horizontal scanning.

Moreover, the first source driver 23-1 generates a dimming signal or a parameter signal denoting a display image parameter (an example of a control signal) based on the first image analysis parameter and the second image analysis parameter. The first image analysis parameter is generated in accordance with the first image signal for the first display area H1. The second image analysis parameter is information denoted by the parameter signal and is generated in accordance with the second image signal for the second display area H2. That is, the first source driver 23-1 controls, in accordance with the dimming signal or the parameter signal denoting the display image parameter, display based on the entirety of image data (entire screen).

Note that the scheme for externally transmitting an image signal to the source driver 23 is not limited to the MIPI specification, For example, an embedded display port (eDF) standard configured to transmit an image signal by a differential signal may be adopted. Alternatively, for example, each image signal may be externally transmitted to each source driver based on the point-to-point system. Here, the point-to-point system is a system for transmitting only the image signal corresponding to a display area to the source driver 23 associated with the display area.

### Second Embodiment

Next, a second embodiment of the present disclosure will be described.

In the second embodiment, an example will be described in which a display module M1a transmits a multiplex signal (a synchronization signal and a parameter signal) over a first synchronization signal line 24a-1. In other words, a parameter signal from a first source driver 23a-1 to a second source driver 23a-2 and a parameter signal from the second source driver 23a-2 to the first source driver 23a-1 are multiplexed on each other and transmitted during a blanking period of the synchronization signal.

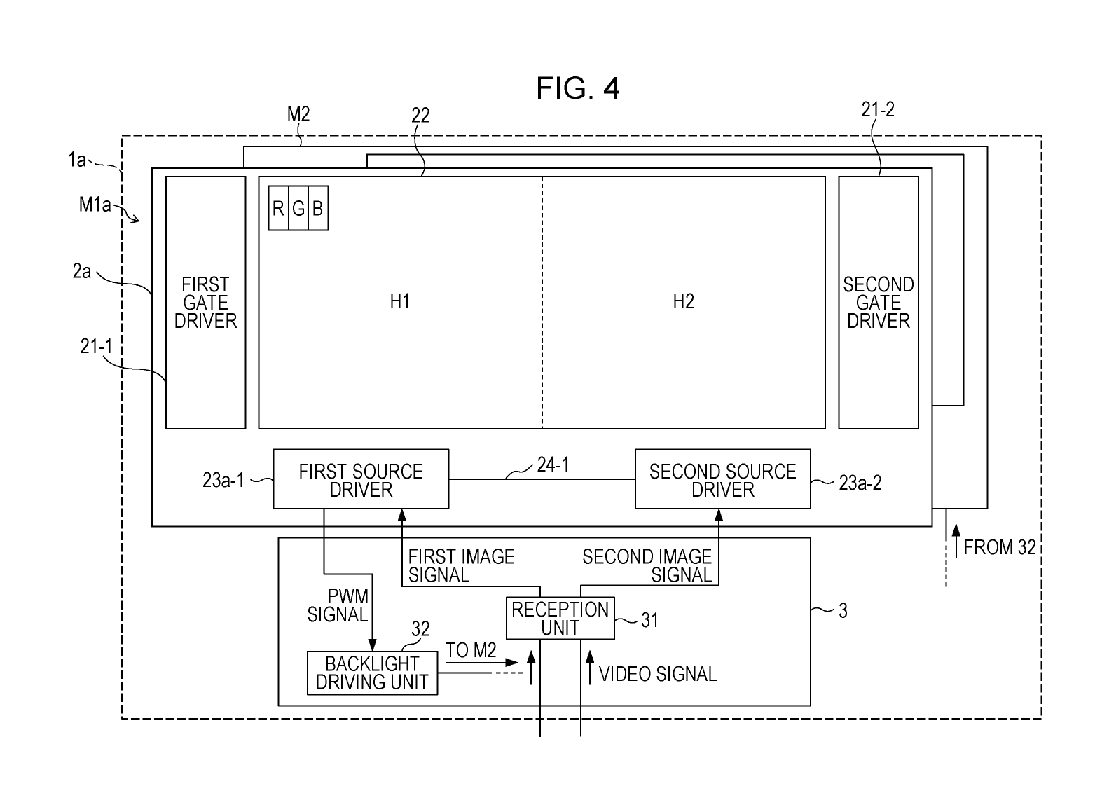

FIG. 4 is a view schematically illustrating a configuration of a display apparatus 1a according to the second embodiment of the present disclosure. The display apparatus 1a (FIG. 4) according to the present embodiment and the display apparatus 1 (FIG. 2) according to the first embodiment are different from each other in the first source driver 23a-1 and the second source driver 23a-2. However, functions of other component are the same as those of the first embodiment. Description of the functions the same as those in the first embodiment will be omitted.

The first source driver 23a-1 and the first source driver 23-1 are different from each other in transmission of a display image parameter, but other functions arc the same. The first source driver 23a-1 multiplexes a parameter signal denoted by a parameter (for example, display image parameter) generated in accordance with a plurality of image analysis parameters and transmits the parameter signal over a first synchronization signal line 24-1.

When the second source driver 23a-2 is compared with the second source driver 23-2, transmission of a display image parameter is different, but other functions are the same. The second source driver 23a-2 receives the parameter signal over the first synchronization signal line 24-1, and in accordance with the parameter (for example, display image parameter) denoted by the parameter signal, the second source driver 23a-2 performs display control of a second display area H2.

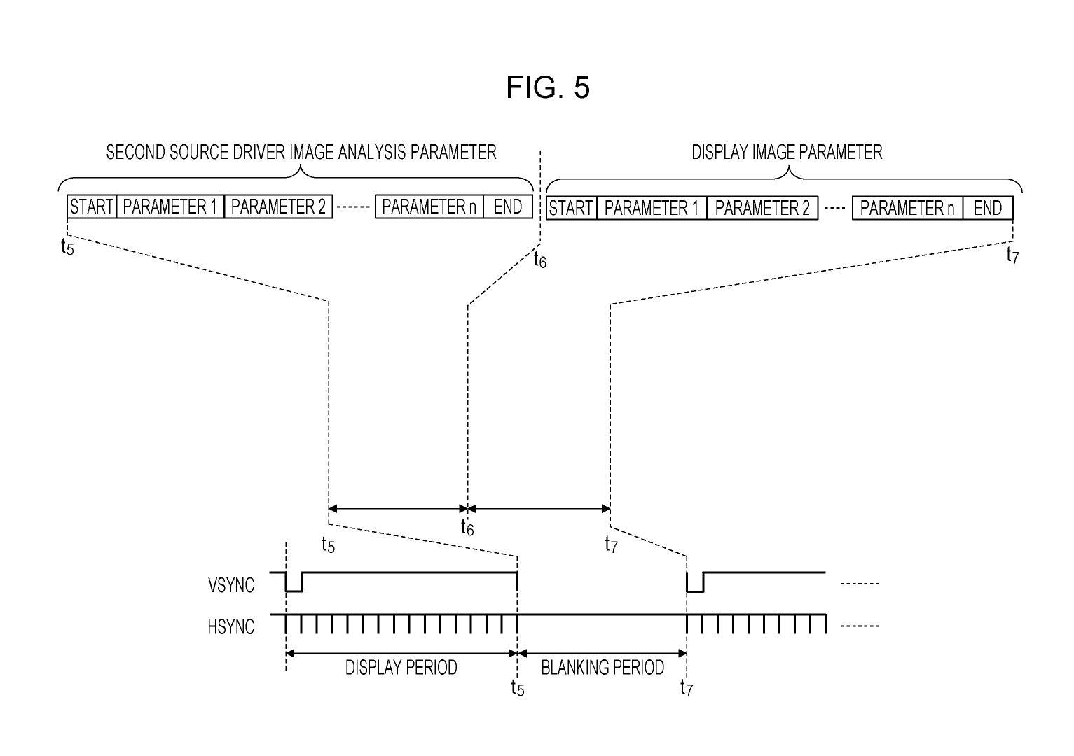

FIG. 5 is a time chart illustrating an example of the synchronization signal and the parameter signal in the present embodiment. The time chart shows waveforms of signals transmitted over the first synchronization signal line 24-1 between, the first source driver 23a-1 and the second source driver 23a-2. In FIG. 5, the horizontal axis is the time axis, and the vertical axis denotes the voltage.

In FIG. 5, between the first source driver 23a-1 and the second source driver 23a-2, two types of synchronization signals (Vsync, Hsync) are transmitted. A period of transmission and reception of these synchronization signals includes a display period and a blanking period. During the display period, display control is performed by a first gate driver 21-1, a second gate driver 21-2, the first source driver 23a-1, and the second source driver 23a-2.

In FIG. 5, image analysis parameters and a display image parameter are inserted into the blanking period. That is, the parameter signal of a second image analysis parameter and the display image parameter are time-multiplexed on the synchronization signal. The second image analysis parameter is a parameter generated by the second source driver 23a-2 in accordance with a second image signal. On the other hand, the display image parameter is a parameter generated by the first source driver 23a-1 in accordance with a first image analysis parameter and the second image analysis parameter.

Here, the second image analysis parameter and the display image parameter axe different in transmission direction. That is, the display image parameter is transmitted from the first source driver 23a-1 to second source driver 23a-2. On the other hand, the second image analysis parameter is transmitted from the second source driver 23a-2 to the first source driver 23a-1. The synchronization signal is transmitted from the first source driver 23a-1 to second source driver 23a-2, but may be transmitted in the reverse direction.

For example, the first source driver 23a-1 stops transmission of Vsync and Hsync during the blanking period. The second source driver 23a-2 transmits the second image analysis parameter during a prescribed period (for example, between a time t₅ and a time t₆) of the blanking period. The first source driver 23a-1 transmits the display image parameter during another prescribed period (for example, between the time t6 and a time t₇) of the blanking period.

### Summary of Second Embodiment

As described above, in the present embodiment, the display module M1a (display apparatus 1a) multiplexes the synchronization signal (an example of a first signal) denoting a timing relating to control of the first source driver 23a-1 and the second source driver 23a-2, the parameter signal denoting the second image analysis parameter generated in accordance with the second image signal, and the display image parameter (an example of a third signal) generated in accordance with the first image analysis parameter and the second image analysis parameter and transmits them over the synchronization signal line 24-1.

According to the present embodiment, the second source driver 23a-2 transmits the second image analysis parameter to the first source driver 23a-1 over the synchronization signal line 24-1, Moreover, the first source driver 23a-1 transmits the synchronization signal and the display image parameter to the second source driver 23a-2 over the synchronization signal line 24-1. That is, unlike the first embodiment, the synchronization signal, the second image analysis parameter, and the display image parameter are transmitted and received over one synchronization signal line, and therefore, it is possible to control the plurality of display areas by a further reduced number of lines, and it is possible to perform satisfactory image processing. Thus, the display module MI enables pattern design of a substrate and a display panel to be more efficiently performed.

In the present embodiment, a backlight driving unit 32 in a control substrate 3 may perform CABC or the like of a backlight module M2 by a PWM signal of a duty ratio based on the display image parameter generated by the first source driver 23a-1. Alternatively, CABC or the like may be performed by transmitting the duty ratio information of the PWM signal.

Similarly to the first embodiment, in the present embodiment, when transmission and reception of a parameter relating to image display during the blanking period is performed between the first source driver 23a-1 and the second source driver 23a-2, the transmission and reception is realized by using only one synchronization signal line. Therefore, it is possible to further efficiently perform pattern design of a substrate and a display panel in the display apparatus 1a.

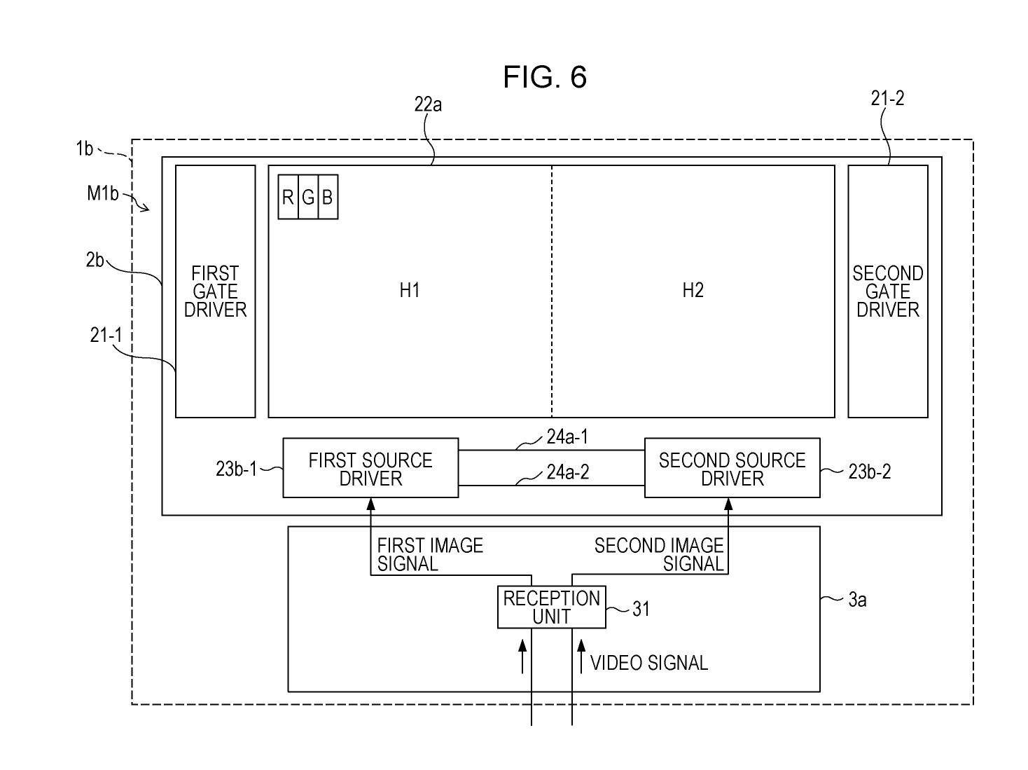

FIG. 6 is a view schematically illustrating a configuration of a display apparatus 1b according to the third embodiment of the present disclosure. Differences from the first embodiment and the second embodiment are that a pixel array 22a itself included in a display panel 2b emits light, that a control substrate 3a includes no backlight driving unit, and that a display apparatus 1b includes no backlight module.

The display apparatus 1b includes a display module M1b, and the display module M1b includes the display panel 2b and the control substrate 3a. The display panel 2b includes the pixel array 22a. Pixels themselves included in the pixel array 22a emit light. The display panel 2b includes a first gate driver 21-1, a second gate driver 21-2, a first source driver 23b-1, and a second source driver 23b-2. The first source driver 23b-1 and the second source driver 23b-2 are connected to each other by a first synchronization signal line 24a-1 and a second signal line 24a-2. Similarly to the first embodiment, the first source driver 23b-1 performs screen display control in accordance with a first image analysis parameter based on a first image signal and a second image analysis parameter transmitted from the second source driver 23b-2.

A method for multiplexing a synchronization signal transmitted and received between the first source driver 23b-1 and the second, source driver 23b-2 and a parameter signal is similar to that of the first embodiment.

The first source driver 23b-1 may determine a parameter of an output of light (corresponding to, for example, luminance or light intensity) from the pixel array 22a in accordance with the first image analysis parameter and the second image analysis parameter, and the parameter may be included in a display image parameter.

Moreover, in the present embodiment, the display panel 2b includes the first synchronization signal line 24a-1 and the second synchronization signal line 24a-2, but even when the number of the synchronization signal lines is one as in the second embodiment, the display panel 2b of the present embodiment may be adopted.

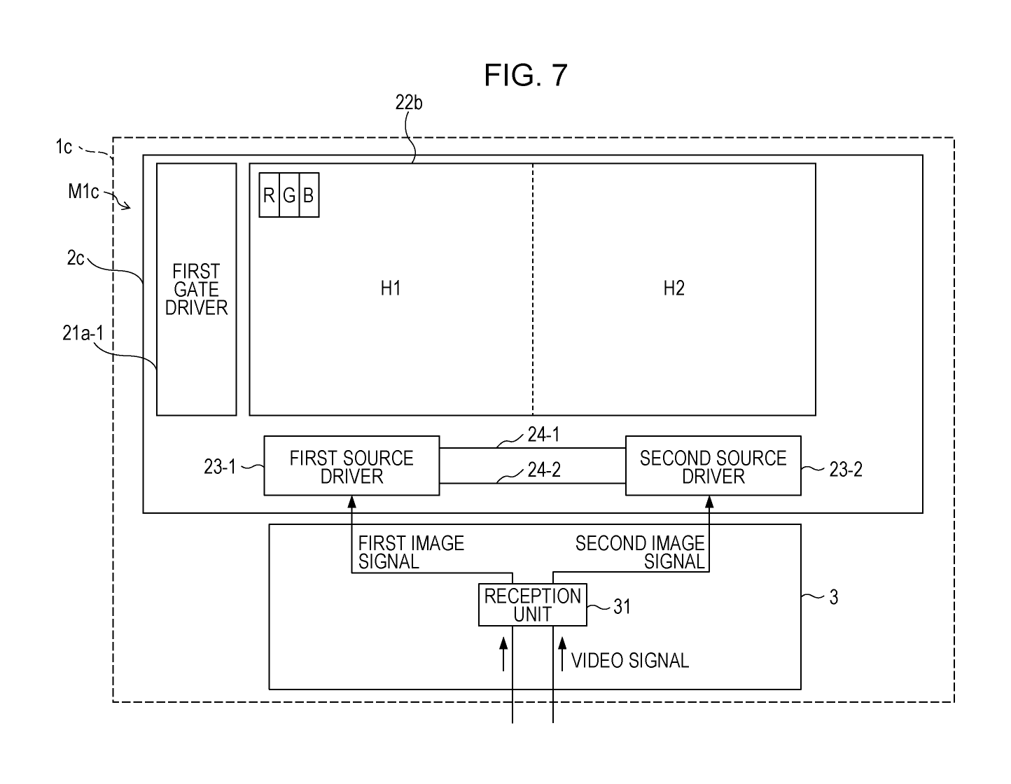

FIG. 7 is a view schematically illustrating a configuration of a display apparatus 1c according to a fourth embodiment of the present disclosure. As illustrated in FIG. 7, in a display panel 2c included in a display module M1c, a first gate driver 21a-1 is provided in a region in the display panel 2c and outside a pixel array 22b, As illustrated in the fourth embodiment, the number of the gate drivers included in the display apparatus 1c may be one.

In the present embodiment, functions of components other than the first gate driver are the same as those of the first embodiment, and therefore, the description of the functions the same as those in the first embodiment will be omitted.

Moreover, the number of gate drivers in the second and third embodiments may be one (not shown) similarly to the present embodiment. In this case, functions of components other than the gate driver are the same as those of the second and third embodiments, and therefore, the description of the functions the same as those in the second and third embodiments will be omitted.

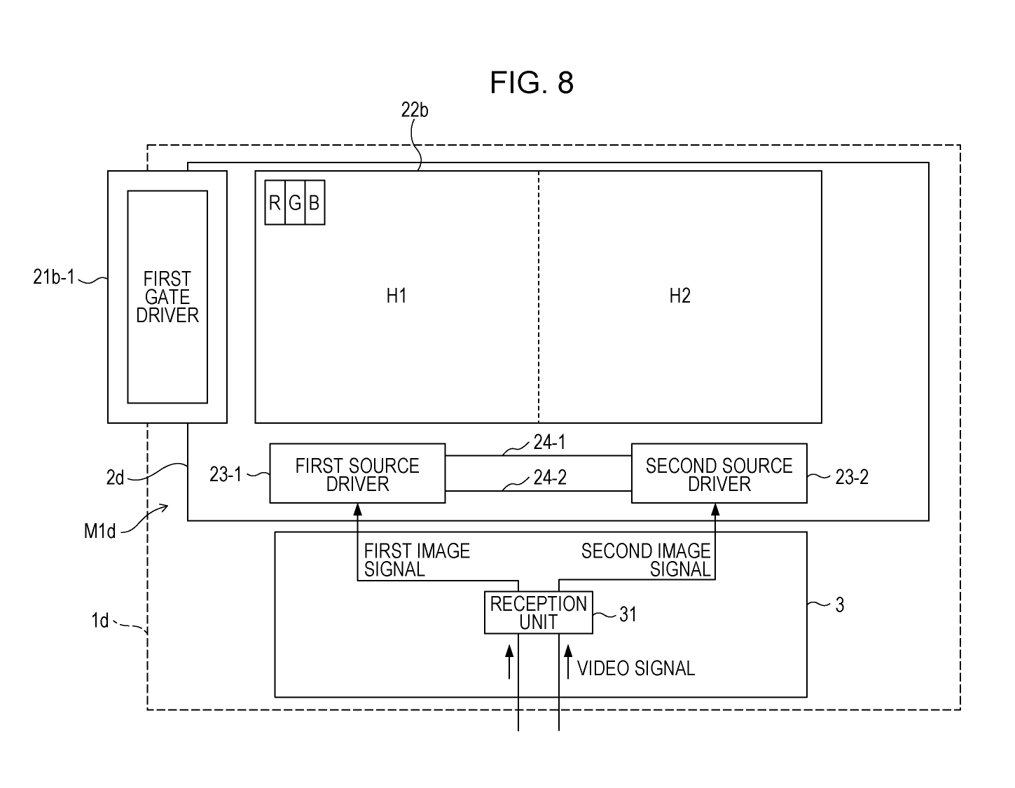

FIG. 8 is a view schematically illustrating a configuration of a display apparatus 1d according to the fifth embodiment of the present disclosure. Unlike the fourth embodiment, in a display module Mid of the present embodiment, a first gate driver 21b-1 is mounted on a film-like substrate. In this case, a mounting form of the first gate driver 21b-1 may be referred to as chip on film (COF), Thus, the first gate driver 21b-1 connected to a display panel 2d may perform display control of the image signal.

In the present embodiment, functions of components other than the first gate driver are the same as those of the fourth embodiment, and therefore, the description of the functions the same as those in the fourth embodiment will be omitted.

Moreover, the first gate driver and the second gate driver in the first, second, and third embodiments may be mounted in the form of COF (not shown). In this case, operation of image control performed by the first gate driver and the second gate driver is as described in the first, second, and third embodiments.

The present disclosure contains subject matter related to that disclosed in Japanese Priority Patent Application JP 2017-246346 filed in the Japan Patent Office on Dec. 22, 2017, the entire contents of which are hereby incorporated by reference.

In the above description, while preferable embodiments according to the present disclosure have been described with reference to the drawings, the present disclosure is not limited to those embodiments. It is clear that those skilled in the art arrives that various modifications and corrections are possible within a scope of technical idea recited in the claims, and they are also within the techniques of the present disclosure.

What is claimed is:

1. A display control apparatus configured to perform display control in accordance with image data, the display control apparatus comprising:
a first drive circuit configured to perform first display control in accordance with a first image signal denoting part of the image data;
a second drive circuit configured to perform second display control in accordance with a second image signal denoting another part of the image data; and
a signal line connected to the first drive circuit and the second drive circuit and configured to transmit a first signal denoting a timing related to control of the first drive circuit and the second drive circuit, wherein
the second drive circuit transmits a second signal over the signal line with the second signal being multiplexed on the first signal, the second signal denoting information generated in accordance with the second image signal.

2. The display control apparatus according to claim 1, wherein
the signal line is configured to transmit synchronization signals for synchronizing control of the first drive circuit and the second drive circuit, and
the second drive circuit transmits the second signal between the synchronization signals.

3. The display control apparatus according to claim 1, wherein
the second drive circuit transmits the second signal during the blanking period of displaying by the display control.

4. The display control apparatus according to claim 1, wherein
the first drive circuit performs display control of a first display area,
the second drive circuit performs display control of a second display area,
the second drive circuit transmits the first signal and the second signal about the display control of the second display area to the first drive circuit over the signal line.

5. The display control apparatus according to claim 4, wherein
the first drive circuit generates a control signal in accordance with
information generated in accordance with a first image signal for the first display area and
information denoted by the second signal and generated in accordance with a second image signal for the second display area.

6. The display control apparatus according to claim 5, wherein
the second drive circuit transmits a signal denoting an analysis result of the second image signal for the second display area to the first drive circuit, and
the first drive circuit generates the control signal for controlling display based on an entirety of the image data in accordance with
the information generated in accordance with the first image signal for the first display area and
the analysis result of the second image signal denoted by the signal.

7. A display apparatus comprising:
the display control apparatus according to claim 1.

8. A control method of a display control apparatus including
a first drive circuit configured to perform first display control in accordance with a first image signal denoting part of the image data,
a second drive circuit configured to perform second display control in accordance with a second image signal denoting another part of the image data, and
a signal line connected to the first drive circuit and the second drive circuit and configured to transmit a first signal denoting a timing related to control of the first drive circuit and the second drive circuit,
the control method comprising:
transmitting a second signal over the signal line with the second signal being multiplexed on the first signal, the second signal denoting information generated in accordance with the first image signal.
